(19) United States
(12) Patent Application Publication
(10) Pub. No.: US 2004/0050094 A1
(43) Pub. Date: Mar. 18, 2004

(54) Method and installation for purifying and recycling helium and use in optical fibre manufacture

(76) Inventors: Jean-Yves Thonnelier, le Bretonneux (FR); Catherine Candela, Claix (FR)

Correspondence Address: Air Liquide, Intellectual Property Department, Suite 1800, 2700 Post Oak Boulevard, Houston, TX, 77056, US

(21) Appl. No.: 10/399,718

(22) PCT Filed: Oct. 10, 2001
(86) PCT No.: PCT/FR01/03126

(30) Foreign Application Priority Data
Oct. 18, 2000 (FR) 00/13342

(51) Int. Cl. B01D 59/12; C01B 3/00; B01J 8/00; B01D 47/00; F25J 1/00; F25J 3/00; B01D 53/22

(52) U.S. Cl. 62/617; 62/608; 62/639; 423/210; 95/53; 96/10

(57) ABSTRACT

The invention concerns a method and an installation for purifying impure helium. Said method consists in subjecting the helium to at least two successive steps: (a) cryogenic refrigeration of impure helium so as to eliminate by condensation at least part of the main impurities it contains and recuperating helium with intermediate purity containing residual impurities; and (b) permeation of at least part of the helium with intermediate purity derived form step (a) so as to eliminate at least part of said residual impurities and recuperating helium with final purity higher than said intermediate purity. Said method and said installation are useful for purifying impure helium recuperated at the output of an optical fibre cooling chamber, prior to the reintroduction of the resulting purified helium into said chamber so as to recycle the helium.

The present invention relates to a process for purifying and recycling helium and its application in the manufacture of optical fibers.

Helium, which is a rare and expensive gas, is used, pure or as a mixture with other gaseous compounds, in many processes, especially in welding, in the medical and respiratory gases field, as cooling gas or marker gas, etc.

Like any inert gas, it is fully preserved in the application in which it is used and is found, generally contaminated, in the discharged gases or waste gases resulting from said use.

Thus, it is known that the manufacture of optical fibers requires several successive operations or steps, namely a deposition step, a consolidation step, a drawing step followed by a coating step, which all consume variable amounts of helium, the step of drawing the fiber being that which consumes most of it.

The step of deposition on the fiber may be carried out using at least four different technologies, namely MCVD, OVD, VAD and PCVD. In most of these techniques, this step is preferably carried out in the presence of high-purity helium, the purity generally being greater than 99% and often at least 99.5%.

The consolidation step may also be carried out using the aforementioned four technologies and, here again, in the presence of high-purity helium, that is to say helium with a purity similar to that of the deposition step.

Between the drawing step and the coating step, the optical fiber must be cooled in an atmosphere of gaseous helium during a cooling step.

This cooling step is conventionally carried out in a heat exchanger, often in the form of an elongate cylinder, through which exchanger at least one fiber to be cooled passes, said fiber being cooled by being brought into contact with a cold gas, preferably helium. However, the helium used during this cooling does not need to be as pure as that used in the preceding steps, that is to say helium with a purity of 80 to 99% suffices.

These various steps are well known to those skilled in the art and for any detail relating to these various steps reference may be made to the following documents which deal with the subject: The Outside Vapor Deposition Method of Fabricating Optical Waveguide Fibers, M. G. Blankenship et al., IEEE Journal of Quantum Electronics, Vol. QE-18, No. 18, p. 1414-1423, 10/1982; Large-Core High N.A. Fibres for Data-Link Applications, P. B. O'Connor et al., Electronics Letters, 31.03.1977, Vol. 13, No. 7, p. 170-171; U.S. Pat. No. 3,932,160 published on 13.01.1976; U.S. Pat. No. 5,254,508 published on 19.10.1993. JP-A-4-240129 and JP-A-60-46954.

In summary, it may be stated that, during the process of manufacturing an optical fiber, the fiber is subjected to various, especially chemical or physicochemical, treatments which take place during the abovementioned steps, which treatments generate a greater or lesser amount of contamination of the helium depending on the step in question.

Thus, during the drawing step, the cooling gas, that is to say helium, used is generally contaminated, especially by atmospheric impurities, such as in particular nitrogen, oxygen, water vapor and argon, that may be introduced into the cooling system, which is never completely gastight.

Moreover, during the fiber and prefiber deposition and consolidation steps, said fiber or prefiber undergoes various chemical or physicochemical treatments which generate impurities, such as nitrogen, oxygen or water vapor, or other compounds, such as HCl, H₂, Si and Ge.

Since helium is an expensive and rare gas, it is desirable to try to utilize the gaseous effluents emanating from these various steps and to do this it is common practice to purify the helium for the purpose of recycling it.

Thus, as explained by the documents JP-A-60-46954, JP-A-4-240129 or EP-A-601 601, the helium used during the cooling step may be recycled, that is to say recovered and purified, i.e. stripped of the impurities that it contains, before being reintroduced into the exchanger for cooling the optical fiber.

The possibility of recycling the helium resulting from the deposition and consolidation steps is also known.

For this purpose, mention may be made of the document EP-A-820 963 which teaches how to recover the helium used during the fiber deposition, consolidation and drawing steps and to combine these various helium streams into a single stream which is subjected to one or more purification steps before being returned, that is to say recycled, into one or more of said steps.

Similarly, the document U.S. Pat. No. 5,890,376 discloses a process for recycling the helium used in the consolidation step. According to that process, the impure helium is recovered, purified and sent back either to the consolidation step, from which it emanated, or to another step of the process, which process requires helium of lower purity, for example the fiber cooling step.

In fact, all these optical fiber manufacturing processes involving the recycling of gas, in particular helium, therefore recommend the purification of the impure helium, that is to say the helium that has been used during one or more process steps, before reintroducing it into the manufacturing process so as to reduce the costs of the process by saving on helium.

At the present time, although various solutions have already been proposed, none of them is actually satisfactory from the standpoint of purification effectiveness, its implementation complexity or its operating cost from the industrial standpoint.

Thus, a number of documents recommend that the helium be purified by adsorption of the impurities that it contains. In this regard, mention may be made of EP-A-739 648 or EP-A-982 273 which recommend the purification of the helium by a PSA (Pressure Swing Adsorption) process using specific adsorbents.

However, these solutions are difficult to implement or are ill-suited to an on-site application, that is to say at the final user's site, since an adsorption purification system must in general be designed for very precise charge conditions in terms of flow rate and composition.

Consequently, any fluctuation in the quantity or quality of the charge may substantially impair the recovery of the desired product, in terms of its purity or of the efficiency, even if you respond by acting on the adsorption cycle, something which it is difficult to imagine doing on an apparatus installed on the premises of a user, such as an optical fiber manufacturer, and, optimally, operated remotely.

However, such fluctuations are normal operating conditions for a reprocessing system that collects the discharges from several lines or from several applications on the same site.

Moreover, it is also known to use one or more membranes for purifying helium contaminated by impurities, as also described by the document EP-A-621 070.

However, such a system is not effective enough when it is expected to achieve helium purity levels compatible with certain applications requiring high-purity helium, such as a process for manufacturing optical fibers.

From this starting point, the object of the invention is to provide a helium purification process that is improved over the existing processes and that has, compared with the prior art, the following advantages:

great flexibility as regards fluctuations in the charge, both in terms of quality and quantity;

degree of helium recovery as high as possible;

simplicity of operation under the conditions of an on-site apparatus placed on the client's premises; and

easy coupling to an optical fiber manufacturing process in order to allow recycling of at least part of the helium used in one or more of the steps of this manufacturing process.

The present invention is based on a combination, in a precise order, of two independently known technologies, namely a cryogenic helium purification step followed by a finishing step or treatment on one or more membranes.

The present invention therefore relates to a process for purifying impure helium, in which the impure helium is subjected to at least the following successive steps: (a) cryogenic refrigeration of the impure helium; and (b) permeation of at least part of the helium resulting from step (a).

More specifically, the invention also relates to a process for purifying impure helium, in which the impure helium is subjected to at least the following successive steps: (a) cryogenic refrigeration of the impure helium so as to remove by condensation at least some of the main impurities that it contains and recovery of intermediate-purity helium containing residual impurities; and (b) permeation of at least some of the intermediate-purity helium resulting from step (a) so as to remove at least some of the said residual impurities and recovery of helium having a final purity higher than said intermediate purity.

Within the context of the invention, the following terms are used:

“optical fiber” denotes both a fiber in its final state or in one of its intermediate states, that is to say in the form of a prefiber, for example not yet or only partially drawn, or partially or completely treated;

“impure” helium denotes helium containing impurities of variable amount, particularly helium that has been brought into contact with an optical fiber in a heat exchanger; and

“impurities” denotes any compound, generally gaseous, other than helium, liable to contaminate said helium, for example nitrogen, oxygen, CO₂, water vapor, argon, HCl, H₂, Si and Ge and mixtures thereof, etc.;

“cryogenic refrigeration of impure helium” denotes a step during which the helium containing impurities is brought into indirect contact with a fluid at a cryogenic temperature, typically at a temperature below about −150° C., for example at the temperature of nitrogen in the liquid state, said contacting operation possibly being carried out by immersion of a coil or of another heat-exchange means conveying impure helium in a bath of liquid nitrogen or by refrigeration of said helium via a heat-exchange system of the countercurrent exchange type, especially one with brazed aluminum plates and fins;

“enclosure” denotes a heat exchanger used for cooling the optical fiber during the drawing step, having a central passage with a fiber inlet orifice via which the optical fiber to be cooled is introduced, a fiber outlet orifice via which the optical fiber cooled by contact with the gas is extracted, a gas inlet orifice via which the cooling gas is introduced and a gas outlet orifice via which the impure gas is extracted.

Depending on the case, the purification process of the invention may include one or more of the following features:

the cryogenic refrigeration of the impure helium is carried out by means of liquid nitrogen or a fluid at a cryogenic temperature brought into indirect contact with said helium, preferably by means of at least one heat exchanger;

the permeation of the helium is carried out by means of one or more membranes, preferably several membranes in cascade;

it includes at least one compression step in which the helium is compressed to a pressure of greater than 10 bar, preferably 20 to 50 bar;

it includes at least one prepurification step, prior to step (a), during which the impure helium is stripped of at least some of its CO₂ and/or H₂O impurities;

during the prepurification step, the CO₂ and/or H₂O impurities are removed by adsorption, preferably by means of zeolite particles, silica gel particles, alumina particles or combinations thereof;

the helium compression is carried out prior to step (a) and by means of at least one compressor, such as a screw compressor;

it includes at least one step of reintroducing some of the helium leaving from the retentate side of at least one membrane into the suction side of the compressor or into an intermediate stage of said compressor;

the impure helium is helium contaminated by the ambient air;

the impure helium is helium containing at least one impurity chosen from the group formed by CO₂, water vapor (H₂O), argon, nitrogen and oxygen, preferably several of said impurities;

the helium resulting from step (a) has a purity of 75 to 98%, preferably 90 to 95%, by volume;

the helium resulting from step (b) has a purity of 97 to 99.99%, preferably 99 to 99.9%.

According to another aspect, the invention also relates to a helium purification installation comprising, connected in series:

cryogenic helium refrigeration means for carrying out cryogenic refrigeration of the helium to be purified; and

permeation means for carrying out purification by permeation of the helium leaving said cryogenic refrigeration means.

Depending on the case, the helium purification installation of the invention may have one or more of the following features:

helium compression means for compressing the helium to be purified are placed upstream of the cryogenic refrigeration means;

the helium compression means comprise a compressor and/or the permeation means comprise one or more membranes or membrane modules;

the retentate outlet of at least one membrane or membrane module is connected to the inlet of at least said compressor.

According to yet another aspect, the invention also relates to a process for manufacturing at least one optical fiber, in which helium purified by a helium purification process according to the invention is used.

In other words, the invention also relates to a process for manufacturing at least one optical fiber, comprising at least the steps of:

(i) introducing gaseous helium into at least one enclosure containing at least one optical fiber portion in order to bring at least said optical fiber portion into contact with the gaseous helium;

(ii) recovering at least some of the impure helium that has been brought into contact with said fiber in said enclosure; and

(iii) purifying the impure helium coming from (ii) by a helium purification process according to the invention.

Similarly, the invention also relates to a process for manufacturing at least one optical fiber, comprising at least the steps of:

(i) bringing gaseous helium into contact with at least one optical fiber portion;

(ii) recovering impure helium that has been brought into contact with said fiber in said enclosure in step (i); and

(iii) purifying the impure helium coming from (ii) by a helium purification process according to the one the invention.

Depending on the case, the optical fiber manufacturing process of the invention may include one or more of the following characteristics:

it includes a step of recycling at least part of the helium purified in step (iii) by bringing said purified helium back into contact with at least one optical fiber portion;

the helium and the optical fiber are brought into contact in at least one cooling enclosure;

the gas used to cool the optical fiber is helium having a purity of 95 to 99.9999% by volume;

it includes at least one fiber deposition step, at least one fiber consolidation step and at least one fiber drawing step, and preferably helium is used in several of these steps.

The purification process of the invention will now be described in greater detail by the explanations that follow and the figures appended hereto, in which:

FIG. 1 shows schematically the cryogenic refrigeration of impure helium by immersion in a liquid nitrogen bath;

FIG. 2 shows schematically the cryogenic refrigeration of impure helium by countercurrent contacting with cryogenic nitrogen;

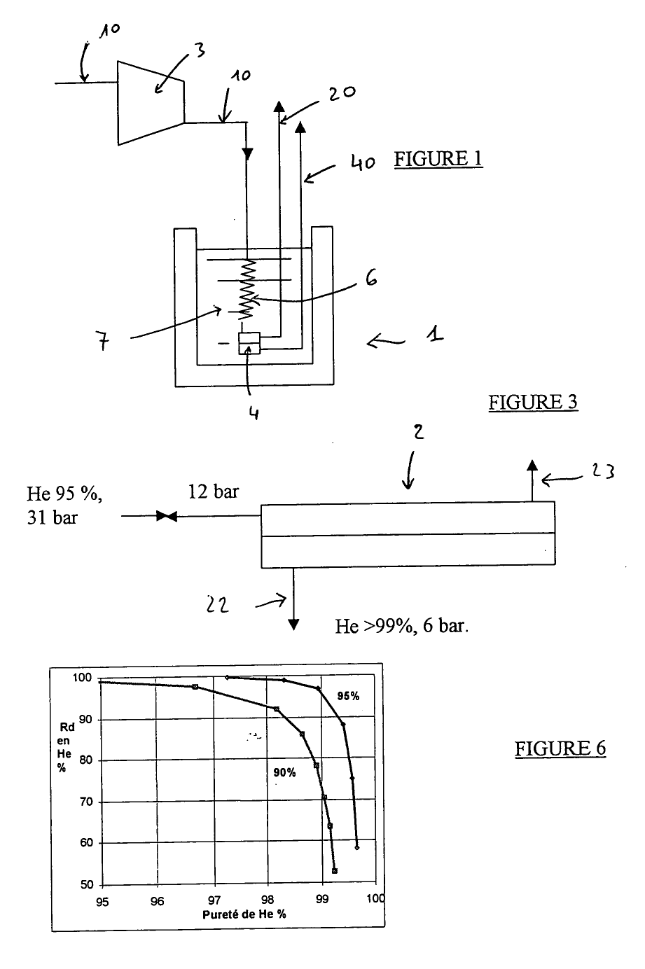

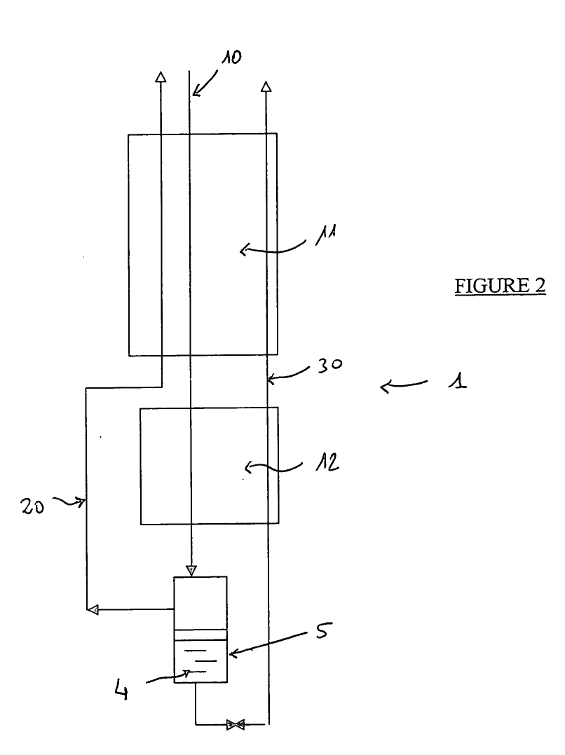

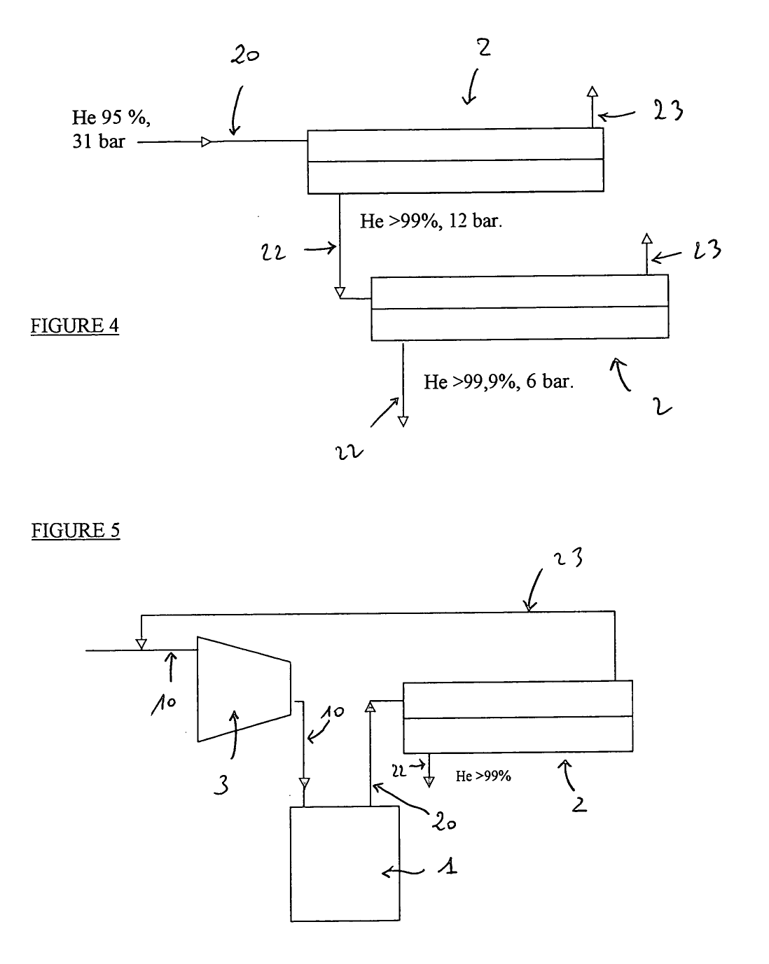

FIGS. 3 and 4 show schematically the step of permeation of the residual impurities contained in the helium;

FIG. 5 shows schematically the succession of steps of the process of the invention with a return to the feed of the compressor;

FIG. 6 is a graphical representation of the data given in the tables below; and

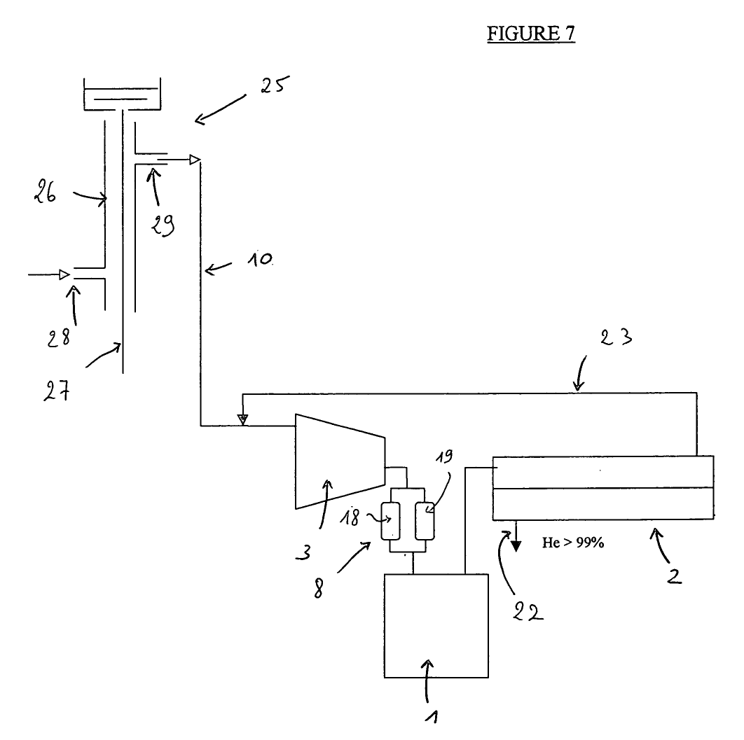

FIG. 7 shows schematically the application of the process of the invention to the manufacture of optical fibers with prepurification of the impure helium.

To make it easier to understand the invention, it will be considered that the helium is contaminated by atmospheric air, that is to say essentially impurities of the CO₂, H₂O, N₂ and O₂ type and the same references are used to denote the same parts in FIGS. 1 to 5 and 7.

According to the invention, the process preferably begins with a helium prepurification step 8, as shown in FIG. 7, consisting of a conventional drying and decarbonization step, after the helium has been compressed to a pressure greater than 10 bar, in general around 20 to 50 bar, intended to remove the traces of moisture (H₂O) and of CO₂ present in the helium.

For example, this prepurification step 8 may be carried out by means of conventional adsorbent particles, such as zeolite particles, silica gel particles, alumina particles or combinations thereof, especially juxtapositions of successive layers of several of these adsorbent materials, which adsorbent particles are placed in one or more adsorbers, preferably at least two adsorbers 18, 19 operating alternately in adsorption cycles with pressure and/or temperature swings, conventionally called PSA (Pressure Swing Adsorption) or TSA (Temperature Swing Adsorption) cycles.

After this prior treatment, the problem amounts to purifying a mixture of helium and decarbonated dry air.

According to the invention, the helium in such a helium/dry air mixture may be purified in two successive steps taken in the following order, namely a cryogenic separation step 1 followed by a membrane permeation step 2, as shown in FIGS. 1 to 5 and 7.

During the cryogenic separation or refrigeration step 1, the cooling, by indirect contacting with liquid nitrogen, of a helium/air mixture 10 which has been compressed (at 3) will cause the condensation 4 of a substantial part of the nitrogen and of the oxygen contained in the helium, the condensates being recovered, for example, in a separator container 5.

The stopping effectiveness is evaluated simply from the vapor pressures of the gases at the cold point temperature (which will be taken as 79 K for a liquid nitrogen at 77 K), i.e.:

in the case of nitrogen: P_{N2}=1.22 bar;

in the case of oxygen: P_{O2}=0.26 bar.

The gas, after condensation at a total pressure of, for example, 31 bar absolute (calculation assumption), then contains 1.22 bar of nitrogen; 0.26 bar of oxygen and 31−(1.22+0.26) bar of helium.

Representing this in percentages, we therefore obtain the following approximate composition of the mixture: N₂=3.93%, O₂=0.85% and He=95.22%; the contents of the other contaminants are considered to be negligible.

Thereafter, two cryogenic treatments may be envisioned, namely:

either a simple condensation step 1 with lost liquid nitrogen, as shown schematically in FIG. 1, that is to say by immersing a coil 6 or the like conveying impure helium 10 in a liquid nitrogen bath 7 in which no refrigeration recovery is provided and the liquid nitrogen performs the entire task of cooling of the gases and condensation 4 of the air, it being possible for the condensates 4 to be removed via a purge line 40;

or a thermodynamically optimized solution, as shown schematically in FIG. 2, using the countercurrent gas/gas exchanges and the expansions at the cold end as taught by Joule-Thomson, in which solution the liquid nitrogen is only a make-up fluid for keeping the system cold, which could even prove to be autothermic for some pressure conditions. This solution, which uses one or more heat exchangers 11, 12, although more complicated, ought however to be preferred since the consumption of nitrogen may become a constraint on the process, that is to say in the case high flow rates and high concentrations of condensables. It should be noted in FIG. 2 that an additional line containing liquid nitrogen could be provided in parallel with the impure helium line 10 and the countercurrent exchange line 30, which contains liquid nitrogen and is connected to the separator container 5.

Next, after the cryogenic treatment 1, the gas 20 resulting from this cryogenic treatment undergoes a permeation purification 2 on one or more membranes, since it is dry, decarbonated and available at a pressure equal to or greater than that generally required for a permeation treatment 2.

This is because the performance of a membrane by itself does not make it possible to go from tens of % of impurities to less than 1% by volume, which is the objective to be achieved in order to obtain high-purity helium that can be used in particular to cool optical fibers during their manufacturing process.

On the other hand, if it is fed, as within the context of the present invention, with the gas 20 obtained by cryogenic treatment 1 (95% He, 5% air), it is very easy, as the tables below and FIG. 6 show, to go from a purity of 95% to one of 99% or higher.

Tables: Performance of the membranes for helium charges of 90% and 95% purity by volume as input.

Trials Carried Out with Feed Gas Containing 95% Helium by Volume

| | | (in %) | (in %) |
|---|---|---|---|
| Retentate side | Permeate side | Qₚₑᵣₘ/Qᵣₑₜ | Helium |

| Q_{feed} | % X_{N2} | % X_{O2} | % X_{He} | Qᵣₑₜ | % Y_{N2} | % Y_{O2} | % Y_{He} | Qₚₑᵣₘ | ratio | yield |
|---|---|---|---|---|---|---|---|---|---|---|
| 25 | 86.282 | 8.303 | 5.415 | 0.617 | 1.919 | 0.815 | 97.258 | 24.383 | 97.533 | 99.869 |
| 35 | 66.592 | 9.073 | 24.335 | 1.574 | 1.052 | 0.620 | 98.328 | 33.426 | 96.502 | 98,848 |
| 45 | 49.047 | 8.026 | 42.925 | 3.165 | 0.592 | 0.488 | 98.940 | 41.835 | 92.966 | 96.822 |
| 60 | 23.763 | 4.765 | 71.472 | 9.483 | 0.290 | 0.293 | 99.417 | 50.517 | 84.195 | 88.110 |
| 75 | 13.520 | 2.945 | 83.535 | 21.359 | 0.209 | 0.220 | 99.565 | 53.641 | 71.521 | 74.958 |
| 100 | 8.778 | 2.014 | 89.207 | 44.516 | 0.166 | 0.186 | 99.648 | 55.484 | 55.484 | 58.198 |

Trials Carried Out with Feed Gas Containing 90% Helium by Volume

| | | | | | | | | | | |
|---|---|---|---|---|---|---|---|---|---|---|
| 15 | 88.104 | 8.376 | 3.519 | 0.696 | 4.105 | 1.690 | 94.205 | 14.304 | 95.363 | 99.819 |
| 25 | 66.620 | 9.625 | 23.756 | 2.291 | 2.086 | 1.231 | 96.684 | 22.709 | 90.836 | 97.581 |
| 40 | 45.547 | 8.211 | 46.242 | 6.293 | 0.990 | 0.840 | 98.170 | 33.707 | 84.267 | 91.916 |
| 50 | 34.469 | 6.836 | 58.695 | 10.824 | 0.686 | 0.664 | 98.650 | 39.176 | 78.351 | 85.882 |
| 60 | 25.394 | 5.566 | 68.040 | 17.318 | 0.537 | 0.553 | 98.910 | 42.582 | 71.138 | 78.179 |
| 70 | 21.429 | 4.692 | 73.879 | 25.175 | 0.458 | 0.488 | 99.054 | 44.825 | 64.036 | 70.478 |
| 80 | 18.376 | 4.123 | 77.501 | 33.794 | 0.411 | 0.447 | 99.142 | 46.206 | 57.758 | 63.625 |
| 100 | 15.009 | 3.487 | 81.524 | 52.155 | 0.350 | 0.400 | 99.240 | 47.845 | 47.845 | 52.757 |

The trials indicated in the above tables were carried out with membrane modules (module 1 pouce =1 inch) obtained from the company MEDAL having a total exchange surface area of 6.7 m², a hollow-fiber length of 0.457 m, a 5/80 selectivity for O₂/He relative to N₂ and with gas pressures of 12 bar as feed and 6 bar on the permeate side.

In the tables, the following abbreviations are used:

Q_{feed} for the flow rate (in m³/h) of the feed gas;

X_{N2}, X_{O2} and X_{He} for the nitrogen, oxygen and helium content, respectively, of the gas recovered on the retentate side (in %);

Y_{N2}, Y_{O2} and Y_{He} for the nitrogen, oxygen and helium content, respectively, of the gas recovered on the permeate side (in %);

Qᵣₑₜ for the flow rate (in m³/h) of the retentate output gas;

Qₚₑᵣₘ for the flow rate (in m³/h) of the permeate output gas.

The results obtained are shown in FIG. 6 for the two purity levels (90% and 95%) of the impure helium, the x-axis giving the purity (in %) of the helium after purification and the y-axis giving the yield (Y) obtained for the helium (in %).

Furthermore, on account of the very high permeability of the membranes for helium and the available pressure (30 bar), the fluxes corresponding to a 30/1 expansion are too high compared with the flows to be treated. In other words, there is in fact a pressure reserve that can be used in various ways:

either to keep some of the purified helium under pressure so as to store it in a buffer tank and then send it to the site of use, at the desired moment;

or to carry out a double membrane purification, as shown in FIGS. 4 or 5, producing helium at a higher purity, that is to say 99.9% or higher.

Of course, each of these helium passes over a membrane is accompanied by the discharge of a non permeated part which will be recycled into the inlet of the compressor.

By increasing the capacity of the compressor and of the cryogenic part in the proportions of the degree of recycling (10 to 20%), it has been found that there may be complete helium recovery, to within the fatal losses that arise in the inversion of the adsorbers 18, 19 or desiccation bottles used during the prepurification 8 of the gas, and in the low fraction of helium dissolved in the condensed air 4, i.e. 1% by volume.

The above calculations may obviously vary slightly depending on the type of membrane, the pressures available in the range of helium compressors and, in general, the overall optimization of the process.

Moreover, helium having these two purity levels may be reused either in different production lines or alternatively on the same production line, especially in the case of the optical fiber application, as shown in FIG. 7.

This FIG. 7 shows schematically an installation 25 for manufacturing an optical fiber 27, comprising an enclosure 26 acting as heat exchanger in which an optical fiber 27 is cooled by gaseous helium introduced into the enclosure 26 via an inlet orifice 28, the impure helium, contaminated especially with incoming atmospheric air, and therefore essentially with impurities of the N₂, O₂, CO₂ and H₂O type, being extracted from the enclosure 26 via an outlet orifice 29.

The impure helium leaving via the outlet orifice 29, for example sucked out by sucking or pumping means, is recovered and taken via the line 10 and compressed at 3 before undergoing the process according to the invention, that is to say before being subjected to the prepurification step 8, then the cryogenic refrigeration step 1 and the membrane permeation step 2.

The purified helium recovered on the permeate side 22 of the membrane 2 may be stored or sent directly into the inlet orifice 28 of the optical fiber manufacturing installation 25.

On the other hand, the helium recovered on the retentate side 23 of the membrane 2 is sent into the line 10, upstream of the compressor 3, or else vented to atmosphere.

It should be noted that if high helium purity is desired, the membrane 2 in FIG. 7, which is moreover also shown in FIG. 3, may be replaced with a system comprising two membranes 2 arranged in cascade, as shown schematically in FIG. 4. In this case, the permeate output 22 from the first membrane feeds the inlet of the second membrane, the purified helium being recovered as permeate output 22 from the second membrane before being sent back into the inlet 28 of the enclosure 26 of the installation shown in FIG. 7, and the gas recovered at the retentate outlets 23 of the first and second membranes may either be sent back, for example as a combined single flow, into the inlet of the compressor 3, as explained above, or may be discharged into the atmosphere, or even used in another application or another process step requiring helium of lower purity.

Of course, if necessary, a helium make-up may be connected to the inlet orifice 28 of the enclosure 26.

1. A process for purifying impure helium, in which the impure helium is subjected to at least the following successive steps:
(a) cryogenic refrigeration of the impure helium; and
(b) permeation of at least part of the helium resulting from step (a).

2. A process for purifying impure helium, in which the impure helium is subjected to at least the following successive steps:
(a) cryogenic refrigeration of the impure helium so as to remove by condensation at least some of the main impurities that it contains and recovery of intermediate-purity helium containing residual impurities; and
(b) permeation of at least some of the intermediate-purity helium resulting from step (a) so as to remove at least some of the said residual impurities and recovery of helium having a final purity higher than said intermediate purity.

3. The process as claimed in either of claims 1 and 2, characterized in that the cryogenic refrigeration of the impure helium is carried out by means of liquid nitrogen brought into indirect contact with said helium.

4. The process as claimed in either of claims 1 and 2, characterized in that the permeation of the helium is carried out by means of one or more membranes, preferably several membranes in cascade.

5. The process as claimed in one of claims 1 to 4, characterized in that it includes at least one compression step in which the helium is compressed to a pressure of greater than 10 bar, preferably 20 to 50 bar.

6. The process as claimed in one of claims 1 to 4, characterized in that it includes at least one prepurification step, prior to step (a), during which the impure helium is stripped of at least some of its CO₂ and/or H₂O impurities.

7. The process as claimed in claim 6, characterized in that during the prepurification step, the CO₂ and/or H₂O impurities are removed by adsorption, preferably by means of zeolite particles, silica gel particles, alumina particles or combinations thereof.

8. The process as claimed in one of claims 1 to 7, characterized in that the compression of the helium is carried out prior to step (a).

9. The process as claimed in one of claims 1 to 8, characterized in that it includes at least one step of reintroducing some of the helium leaving from the retentate side of at least one membrane into the suction side of the compressor or into an intermediate stage of said compressor.

10. The process as claimed in one of claims 1 to 9, characterized in that the impure helium is helium contaminated by the ambient air.

11. The process as claimed in one of claims 1 to 10, characterized in that the impure helium is helium containing at least one impurity chosen from the group formed by CO₂, water vapor (H₂O), argon, nitrogen and oxygen, preferably several of said impurities.

12. The process as claimed in one of claims 1 to 11, characterized in that the helium resulting from step (a) has a purity of 75 to 98%, preferably 90 to 95%, by volume.

12. The process as claimed in one of claims 1 to 11, characterized in that the helium resulting from step (b) has a purity of 97 to 99.99%, preferably 99 to 99.9%.

13. A helium purification installation comprising, connected in series:
cryogenic helium refrigeration means (1) for carrying out cryogenic refrigeration of the helium to be purified; and
permeation means (2) for carrying out purification by permeation of the helium leaving said cryogenic helium refrigeration means (1).

14. The installation as claimed in claim 13, characterized in that helium compression means (3) for compressing the helium to be purified are placed upstream of the cryogenic refrigeration means (1).

15. The installation as claimed in claim 13 or 14, characterized in that the helium compression means (3) comprise a compressor, the permeation means (2) comprise one or more membranes or membrane modules and/or prepurification means (8, 18, 19) are placed upstream of the cryogenic refrigeration means (1).

16. The installation as claimed in claim 13 or 14, characterized in that the retentate outlet of at least one membrane or membrane module (2) is connected to the inlet of at least said compressor (3).

17. A process for manufacturing at least one optical fiber, in which helium purified by a helium purification process as claimed in one of claims 1 to 12 is used.

18. A process for manufacturing at least one optical fiber, comprising at least the steps of:
(i) introducing gaseous helium into at least one enclosure containing at least one optical fiber portion in order to bring at least said optical fiber portion into contact with the gaseous helium;
(ii) recovering at least some of the impure helium that has been brought into contact with said fiber in said enclosure; and
(iii) purifying the impure helium coming from (ii) by a helium purification process as claimed in one of claims 1 to 12.

19. A process for manufacturing at least one optical fiber, comprising at least the steps of:
(i) bringing gaseous helium into contact with at least one optical fiber portion;
(ii) recovering impure helium that has been brought into contact with said fiber in said enclosure in step (i); and
(iii) purifying the impure helium coming from (ii) by a helium purification process as claimed in one of claims 1 to 12.

20. The manufacturing process as claimed in one of claims 17 to 19, comprising a step of recycling at least part of the helium purified in step (iii) by bringing said purified helium back into contact with at least one optical fiber portion.

21. The manufacturing process as claimed in one of claims 17 to 20, in which the helium and the optical fiber are brought into contact in at least one cooling enclosure.

22. The manufacturing process as claimed in one of claims 17 to 21, characterized in that the gas used to cool the optical fiber is helium having a purity of 95 to 99.9999% by volume.

23. The manufacturing process as claimed in one of claims 17 to 22, characterized in that it includes at least one fiber deposition step, at least one fiber consolidation step and at least one fiber drawing step, and preferably helium is used in several of these steps.

24. An installation (25) for manufacturing at least one optical fiber (27), comprising:
at least one enclosure (26) containing at least one optical fiber portion (27), said enclosure (26) having at least one inlet orifice (28) via which gaseous helium is introduced into said enclosure (26) and at least one outlet orifice (29) via which contaminated gaseous helium is extracted from said enclosure (26); and
a helium purification installation as claimed in one of claims 13 to 16, connected, on the upstream side, to the outlet orifice (29) so as to be fed with helium to be purified, extracted from said outlet orifice (29) and, on the downstream side, to the inlet orifice (28) so as to feed said inlet orifice (28) with purified helium.
